(19) United States
(12) Patent Application Publication
(10) Pub. No.: US 2010/0185888 A1
(43) Pub. Date: Jul. 22, 2010

(54) MICROCHIP FOR MONITORING AN ELECTRICAL SUBASSEMBLY

(75) Inventors: Ulrich Hahn, Neustadt/A. (DE); Rainer Siess, Erlangen (DE)

Correspondence Address: HENRY M FEIEREISEN, LLC;HENRY M FEIEREISEN, 708 THIRD AVENUE, SUITE 1501, NEW YORK, NY, 10017, US

(73) Assignee: Siemens Aktiengesellschaft, Munchen (DE)

(21) Appl. No.: 12/063,462

(22) PCT Filed: Jul. 28, 2006
(86) PCT No.: PCT/EP2006/064789

§ 371 Date: Feb. 11, 2008

(30) Foreign Application Priority Data
Aug. 11, 2005 (DE) 10 2005 038 130.8

(51) Int. Cl. G06F 1/28

(52) U.S. Cl. 713/340; 713/502

(57) ABSTRACT

The invention relates to a microchip (1) for monitoring an electrical subassembly (12). Said microchip (1) comprises a means (3) for monitoring a supply voltage (9, 11) of the subassembly as well as a watchdog unit (4) for monitoring a program flow of a microprocessor (6). The invention makes it possible to reduce the space requirements of circuits used for performing safety-related functions in order to monitor an electrical subassembly (12).

The invention relates to a microchip for monitoring an electrical subassembly.

For electrical subassemblies (e.g. in the technical field of machine tools, production machines, elevators, cranes and/or robots) which also include safety-related functions, e.g. according to the standard EN 61508, it is necessary, in addition to a means of voltage supervision for monitoring the supply voltage, to have a watchdog unit for monitoring a program flow of a microprocessor present in the subassembly, and a reset means for resetting the microprocessor in the event of under- and/or overvoltage, and a switching means for powering down the voltage supply, in the event e.g. of overvoltage.

For the monitoring of such a subassembly, it was previously customary in trade to implement the aforementioned components with discrete individual electrical circuits, separated from one another. Thus in customary practice the implementation of the safety-related functions means a high space requirement. The high number of separately constructed individual circuits for the implementation of the aforementioned safety functions leads to a high overall failure rate (fit value (failure in time)) in the failure probability calculation for the subassembly. The discrete structure of the safety-relevant functions with separate individual circuits also results in a high dissipation of thermal power and high costs for material, printed circuit board and production.

The invention is based on the object of reducing the space requirement of circuits for the implementation of safety-related functions for monitoring an electrical subassembly.

This object is achieved with a microchip for monitoring an electrical subassembly, the microchip having
a means of voltage supervision for monitoring a supply voltage of the subassembly and
a watchdog unit for monitoring a program flow of a microprocessor.

A first advantageous development of the invention is characterized in that the microchip has an internal switching means for powering down the supply voltage of the subassembly.

Alternatively or additionally, the microchip can have a drive output for driving an external switching means for powering down the supply voltage of the subassembly. It is hereby made possible that, in particular when large switching powers are necessary, an external switching means can also be connected to the microchip.

It further proves to be advantageous that the external switching means is developed as a semiconductor switch or as an electromagnetic switch. A development of the switching means as a semiconductor switch or as an electromagnetic switch is represented by designs of a switching means which are customary in trade.

It further proves to be advantageous that the microchip has a reset means for resetting the microprocessor in the event of undervoltage of the supply voltage. It is thereby ensured that in the event of undervoltage of the supply voltage the microprocessor is reset, and remains in the reset state as long as the undervoltage continues.

It further proves to be advantageous if the means of voltage supervision monitors the supply voltage both for overvoltage and for undervoltage.

It is thus ensured that the subassembly is monitored for both undervoltage and overvoltage.

It further proves to be advantageous if the microchip has an input for setting a lower and/or an upper limit voltage value. The setting of an individual lower and upper limit voltage value is thereby enabled.

It further proves to be advantageous if the watchdog unit has a counter, the value of the counter being readable upon a trigger signal from the microprocessor. An especially good monitoring of the microprocessor's program flow is thereby enabled.

It further proves to be advantageous if the microchip has a clock generation means for generating a counter clock for the watchdog unit. An especially high level of integration is thereby achieved.

Alternatively, it can also be advantageous if an external clock generation means is provided for generating a counter clock for the watchdog unit, the external clock generation means being connected to the microchip via a line. This development of the invention has the advantage that a clock generation means common to the trade can be used as the external clock generation means.

It further proves to be advantageous if the microchip has a serial and/or a parallel interface. The counter clock of the watchdog unit can be read out by the microprocessor with the help of a serial and/or parallel interface, for example.

It further proves to be advantageous if the delay time of the watchdog unit is selectable. The user is thereby enabled to adapt the delay time individually to the circumstances.

It moreover proves to be advantageous if the microchip has a memory unit, the memory unit being developed in such a way that data stored in the memory unit can no longer be changed after the initial storing of the data in the memory unit. Subsequent accidental amendment of the data is reliably prevented by this means, for example.

It further proves to be advantageous that the means of voltage supervision and/or the watchdog unit and/or the reset means are developed as electrical circuits which are physically present. If the means of voltage supervision and/or the watchdog unit and/or the reset means are developed as electrical circuits which are physically present, and in particular essentially as analog electrical circuits, then the microchip works especially reliably, since the means of voltage supervision and/or the watchdog unit and/or the reset means are not implemented in the form of a program on a processor integrated in the microchip.

It moreover proves to be advantageous if the microchip has a control input and a control output for the purpose of interconnecting several microchips. It thereby becomes possible also to connect several microchips according to the invention to one another, in order that e.g. if the monitoring functions implemented on a single microchip are not sufficient for monitoring the entire subassembly, several microchips can be used in a compound for monitoring the subassembly.

It further proves to be advantageous to develop a subassembly with the microchip, since among other things the subassembly can then be built smaller.

In principle the microchip according to the invention is suitable for monitoring any electrical subassemblies. The use of an electrical subassembly with the microchip according to the invention is advantageous in particular for machine tools, production machines, elevators, cranes and/or robots, since the requirements for the monitoring of the electrical subassemblies used are particularly stringent in this technical field.

An embodiment of the invention is represented in the drawing, and will be further described in detail. Shown is:

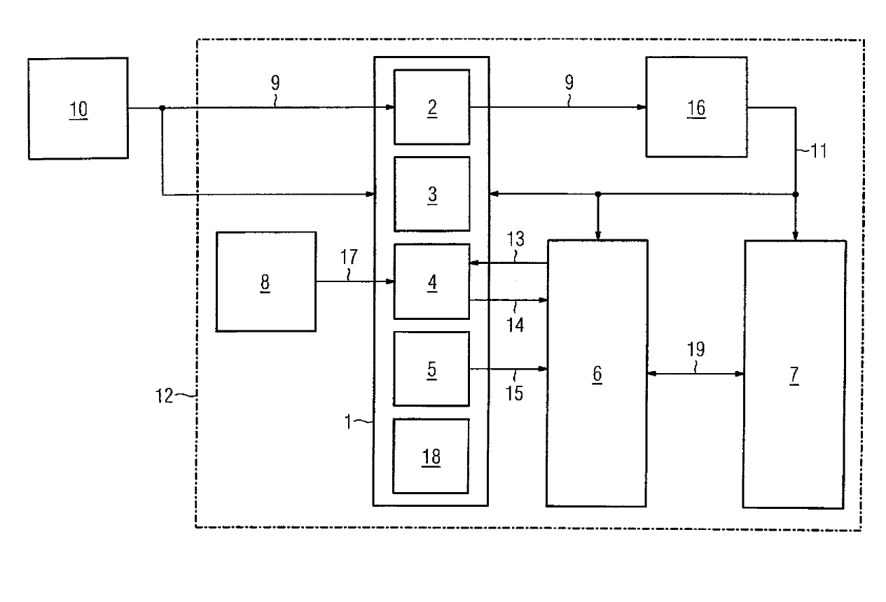

FIG. 1 an electrical subassembly with a microchip according to the invention.

In FIG. 1 an electrical subassembly 12, which is supplied with electrical energy from an external voltage supply unit 10, which provides the external supply voltage 9, is represented in the form of a block diagram. The external supply voltage 9 is fed on the subassembly 12 to an internal voltage supply unit 16, which provides an internal supply voltage 11 at its output for the purpose of supplying the electrical components of the subassembly 12. The internal supply voltage 11 serves for the voltage supply to a microprocessor 6 and other electrical components 7 of the subassembly. Further electrical subassemblies and/or further microprocessors of the subassembly can also optionally be supplied with power with the help of the internal supply voltage 11.

For the purpose of monitoring the electrical subassembly 12, a microchip 1 according to the invention is also on the subassembly. Within the scope of the embodiment, the microchip 1 has as integral elements a means of voltage supervision 3, a switching means 2, a watchdog unit 4 and a reset means 5. Discrete individual electrical circuits, separated from one another, are thus no longer used as customary in trade, for the switching means 2, for the means of voltage supervision 3, for the watchdog unit 4 and for the reset means 5. This results in a clearly reduced space requirement for the implementation of the monitoring functionalities, with simultaneously clearly reduced overall failure numbers for the subassembly.

As already mentioned above, the microchip has a means of voltage supervision 3, to which in the embodiment both the external supply voltage 9 and the internal supply voltage 11 are fed for monitoring. It should be noted here that optionally also only the external supply voltage or only the internal supply voltage can be monitored. In the embodiment, both the external supply voltage 9 and the internal supply voltage 11 are monitored for over- and undervoltage.

The microchip has the internal switching means 2, which in the embodiment is present in the form of a semiconductor switch, e.g. a transistor. If the means of voltage supervision 3 detects that there is an over- or undervoltage of the external and/or internal supply voltage, then the switching means 2 is driven in such a way by the means of voltage supervision 3, the switching means 2 being connected between the external voltage supply unit 10 and the internal voltage supply unit 16, that the external voltage supply 9, which serves to supply the internal voltage supply unit 16, is interrupted. Alternatively or additionally the microchip 1 can also have a drive output for driving an external switching means, i.e. a switching means that is no longer an integral element of the microchip, for powering down the supply voltage of the subassembly. The external switching means is then driven in such a way by the drive output of the microchip that the external switching means interrupts the external voltage supply 9 in the event of an over- or undervoltage. This option is advantageous in particular if high currents have to be cut off, which a switching means integrated in the microchip can no longer switch; or which are too great for the microchip in normal operation as a result of the heat arising from the power dissipation. In the case of an external switching means, the switching means can e.g. likewise be developed as a semiconductor switch (e.g. transistor) or as an electromagnetic switch.

The microchip 1 further has the reset means 5 as an integral element. In the case of an undervoltage of the internal supply voltage 11, the reset means 5 generates a reset signal 15 to reset the microprocessor 6. With the help of the reset signal 15, the microprocessor is permanently blocked in the case of an undervoltage. When the internal supply voltage is once again in the permissible range, the reset means 5 continues to send the reset signal 15 for a defined period of time, and thus blocks the microprocessor 6, in order to ensure a correct startup for the microprocessor later.

The microchip 1 further has the watchdog unit 4 as an integral element. The watchdog unit 4 serves for monitoring a correct program flow of the microprocessor 6. For this purpose the watchdog unit 4 has a counter, which is driven by a clock generation means integrated on the microchip for generating a counter clock. If the microprocessor does not send a trigger signal 13 to the watchdog unit 4 at regular intervals before the value of the counter of the watchdog unit 4 exceeds a defined limit, then the watchdog unit 4 generates the reset signal 15 to reset the microprocessor 6, and activates the switching means 2 so that the external supply voltage 9 is interrupted. The clock generation means for generating the counter clock for the watchdog unit 4 need not necessarily be an integral element of the microchip 1, but can also be disposed outside the microchip 1 in the form of an external clock generation means 8. The external clock generation means 8 is then connected via a line 17 to the microchip 1.

In an especially advantageous embodiment, the watchdog unit 4 sends the current value 14 of the counter to the microprocessor 6, i.e. the value of the counter can be read out by the microprocessor 6 upon the trigger signal 13. The counter value 14 read in by the microprocessor 6 can then be checked for plausibility by the microprocessor within a program running on the microprocessor 6. An improved monitoring functionality is enabled in this way. In an advantageous embodiment, it is further possible also to select the delay time, i.e. the maximum time permitted before a trigger signal 13 must again occur for the resetting of the counter.

In the embodiment, the microchip 1 has a parallel interface, with the help of which a lower and/or an upper limit voltage value for the means of voltage supervision 3 can be defined, e.g. by the user.

The microchip 1 can optionally additionally have a memory unit 18 as an integral element, which is developed in such a way that data stored in the memory unit 18 can no longer be changed after the initial storing of the data in the memory unit 18. The memory unit 18 can e.g. be present as a ROM/PROM or e.g. as a memory unit that can be written once with data by means of fuse or anti-fuse technology.

The means of voltage supervision 3 and/or the watchdog unit 4 and/or the reset means 5 can be implemented as an integral element of a program, which runs on a processor integrated on the microchip. To achieve especially high reliability for the microchip 1, however, it is sensible for the means of voltage supervision 3 and/or the watchdog unit 4 and/or the reset means 5 to be developed as physically present electrical circuits as in the embodiment, so that non-essential parts of the microchip 1 are present in the form of a processor.

It should be noted here that the microchip 1 can have not only a single means of voltage supervision for monitoring a single supply voltage of the subassembly, but naturally the microchip 1 can also have multiple means of voltage supervision 3, which serve for monitoring multiple supply voltages. It can be remarked here that in particular the internal voltage supply unit 6 often supplies not only one single internal supply voltage as an output signal, since different supply voltage levels are often needed for supplying a subassembly. In this context it is naturally also possible that for each supply voltage to be monitored, the microchip has a separate input in each case for setting a lower and/or an upper limit voltage value.

The microchip 1 can optionally also have a control input and a control output for the purpose of interconnecting several of the microchips according to the invention. If the number of required monitoring functionalities, e.g. the number of supply voltages to be monitored, which can be monitored by a single microchip, exceeds the number of monitoring functionalities implemented on a single microchip, then several microchips can also be interconnected one to another. If one of the microchips reacts to a faulty state, it sends an error signal via its control output to the control inputs of the other microchips, as a result of which each microchip e.g. then causes a deactivation of the supply voltage and/or a reset of the microprocessor.

Located on the subassembly 12 are electrical components 7, which communicate with the microprocessor 6, as indicated by an arrow 16. It should be noted here that the subassembly 12 can also be used for the electrical energy supply to further subassemblies, which optionally also communicate with the microprocessor 6. Thus with the help of the microchip according to the invention it is possible that not only a single subassembly 12 is monitored, but also several subassemblies also connected to the subassembly 12, which e.g. likewise obtain their internal supply voltage from the internal voltage supply unit 16 of the subassembly 12.

The microchip can be used especially advantageously in the technical field of machine tools, production machines, elevators, cranes and/or robots, since the subassemblies used in these technical fields often have to have a monitoring functionality.

With the help of the microchips according to the invention, safety-related circuits in particular can be implemented e.g. with actuator or sensor functionality. The microchip leads to a reduction of the overall failure rate compared to previous implementations constructed with discrete individual electrical circuits, since the overall failure rate of a microchip is recognizably lower than the sum of the failure rates of individual circuits. The invention allows more individual components to be accommodated on a subassembly, machine or system without causing the PFH value (Probability of Failure per Hour) to be exceeded. The invention further has the advantage of a major saving of space and a reduction of the dissipation of thermal power for the monitoring function. Furthermore, the invention also leads to a corresponding cost reduction for material, printed circuit board and the production of the subassembly.

Also, of course, not all the aforementioned monitoring functionalities need be implemented on the microchip 1. In a minimal development of the microchip, it is also possible to implement only the means of voltage supervision 3 and the watchdog unit 4 on the microchip 1, while the other monitoring components such as the reset means 5, the switching means 2 or the memory unit 18 can still be implemented as discrete individual circuits separated externally from the microchip 1.

The microchip can be constructed on a semiconductor basis or a polymer basis.

Within the scope of the invention, the term supply voltage of a subassembly should be understood both as an internal supply voltage of the subassembly and as an external supply voltage of the subassembly.

It should also be noted here that within the scope of the invention, the concept of an electrical subassembly also includes a sensor and/or an actuator.

1.-17. (canceled)

18. A microchip for monitoring an electric subassembly having a microprocessor, the microchip comprising
a voltage monitoring unit for monitoring a supply voltage of the subassembly;
a watchdog unit for monitoring a program flow of the microprocessor; and
a memory unit configured such that initially stored data in the memory unit cannot be subsequently changed.

19. The microchip of claim 18, further comprising an internal switching unit for disconnecting the supply voltage from the subassembly.

20. The microchip of claim 18, further comprising a control output for controlling an external switching unit for disconnecting the supply voltage from the subassembly.

21. The microchip of claim 20, wherein the external switching unit means is configured as a semiconductor switch or as an electromagnetic switch.

22. The microchip of claim 18, further comprising an input for presetting at least one of a lower and an upper voltage limit.

23. The microchip of claim 18, further comprising a reset unit for resetting the microprocessor if the supply voltage falls below a preset lower voltage limit.

24. The microchip of claim 18, wherein the voltage monitor monitors the supply voltage and detects if the supply voltage falls below a preset lower voltage limit or exceeds a preset upper voltage limit.

25. The microchip of claim 18, wherein the watchdog unit includes a counter, wherein a value of the counter is transmitted to the microprocessor before the watchdog unit receives a trigger signal from the microprocessor.

26. The microchip of claim 18, further comprising a clock generator for generating a counter clock sequence for the watchdog unit.

27. The microchip of claim 26, wherein the clock generator is external to the microchip and connected to the microchip by a line.

28. The microchip of claim 18, further comprising at least one of a serial and parallel interface.

29. The microchip of claim 25, wherein the trigger signal resets the counter, and wherein a maximum delay time between trigger signals for resetting the counter is selectable.

30. The microchip of claim 23, wherein at least one of the voltage monitoring unit, the watchdog unit and the reset unit are implemented as physical electric circuits.

31. The microchip of claim 18, further comprising a control input and a control output for connecting at least one additional microchip.

32. An electric subassembly comprising:
a microprocessor; and
a microchip for monitoring the electric subassembly, the microchip including
a voltage monitoring unit for monitoring a supply voltage of the subassembly;
a watchdog unit for monitoring a program flow of the microprocessor; and
a memory unit configured such that initially stored data in the memory unit cannot be subsequently changed.

33. A machine tool, production machine, elevator, crane or robot which includes the electric subassembly of claim 32.
